(19) United States
(12) Patent Application Publication
(10) Pub. No.: US 2014/0346165 A1
(43) Pub. Date: Nov. 27, 2014

(54) OLED PACKAGE HEATING DEVICE AND METHOD THEREOF

(71) Applicant: EverDisplay Optronics (Shanghai) Limited, Shanghai (CN)

(72) Inventor: XiaoHu Zhao, Shanghai (CN)

(73) Assignee: EverDisplay Optronics (Shanghai) Limited, Shanghai (CN)

(21) Appl. No.: 14/281,465

(22) Filed: May 19, 2014

(30) Foreign Application Priority Data
May 22, 2013 (CN) 201310194247.7

(51) Int. Cl. H05B 6/64; H05B 6/80

(52) U.S. Cl. CPC H05B 6/6408; H05B 6/80
USPC 219/756

(57) ABSTRACT

An OLED package heating device and process, this device includes a microwave generator and a reaction chamber. There is a mask in the bottom of the reaction chamber. At the bottom of the mask there is a quartz layer, and on the surface of the mask there is a metal layer. This metal layer is set with at least one opening. At the top of the reaction chamber there provides a reflective plate, and the lower surface of the reflector plate is made of a metal material. In the sintering process, first of all, coating a plurality frit in the reaction chamber, wherein the position of the frit is right above the openings on the mask, then using the microwave generator emit the microwave, wherein the microwave is transmitted through the tube into the reaction chamber to heat the frit.

### CROSS-REFERENCE TO RELATED APPLICATIONS

The present application claims priority to and the benefit of Chinese Patent Application No. CN 201310194247.7, filed on May 22, 2013, the entire content of which is incorporated herein by reference.

### BACKGROUND OF THE INVENTION

1. Field of the Invention

The present disclosure generally relates to the process of the OLED packaging, more specifically, to an OLED package heating device and a method thereof.

2. Description of the Related Art

OLED is the abbreviation of Organic Light-Emitting Diode, and OLED is also called Organic Electroluminesence Display. OLED owns self luminescent characteristic, as it is manufactured by a very thin film of the organic materials and the glass substrate process. The organic materials will send out light when the current is passed. Due to this characteristic, OLED provides a wide viewing angle and is more power-efficient, which make OLED be widely applied. With the development of the OLED technology, the requirements for OLED technology are also getting higher and higher. The processes for manufacturing OLED comprise a packaging process, and this packaging process generally adopts the method of laser frit for packaging, including the following steps: Step 1, a layer of the frit is coated on the surface of a hard substrate; Step 2, the frit is treated by the process of sintering; Step 3, the coating process and the curing process of ultraviolet (UV) are performed; Step 4, the laser frit process and the packaging process are performed. The production period in Step 2 is about 180 minutes, but it is so long as to lead a low productivity. In addition, there is another problem for matching the tact time in the Step 2. Hence, there are some other processes needed to prevent this problem.

In the present technologies, two methods are usually adopted to prevent the problem for matching the tact time.

One method is using the way of heating in the vertical quartz chamber, wherein the frit is sintered on a plurality of pieces of the glass substrate at the same time. When this method is used for preventing the problem of matching the tact time, as the waiting times for the frit in different positions are not the same, the shape of the frit will be influenced by the liquidity of the frit, thus the further packaging process will be affected.

The other method is using the way of heating in the tunnel chamber, wherein the hard substrate will be sintered in the long tunnel chamber when heated. When this method is used for preventing the problem of matching the tact time, the time for operating the hard substrate will be so long that the particles are easy to be emitted, and then the performance of the device will be affected. In addition, as the length of the tunnel chamber is so long that the prevent maintenance (PM) will be complicated, the production period will be longer and the production efficiency will be lower. In the meantime, the cost of the production will be increased.

As the above two methods both use the way of indirectly heating and the hard substrate is also heated in the process of heating, both methods will lead to the occurrence of the heat conduction and the heat convection. Therefore, it will also generate a great temperature gradient so that the production consumes will be increased. In addition, the temperature of the frit will be higher after the process of heating so that the time for cooling the frit will be longer and the production efficiency will be further reduced.

FIG. 1 shows a diagram of the sintering process of the OLED packaging process in the traditional technology. As shown in FIG. 1, the traditional process adopts a vertical quartz chamber or a tunnel chamber to heat and sinter the frit. In other words, when the frit is heated by the heat source, the hard substrate is also heated by the heat source at the same time. Therefore, the production period will be longer and the production efficiency will be lower, thus the cost of the production will be increased.

In a related art, it has provided a light emitting diode epoxy resin encapsulation heating and curing device, comprising a thermal insulation baking channel, a transmission device in the thermal insulation baking channel, an exhaust port provided on the thermal insulation baking channel, a die bar support arranged on the transmission device in the thermal insulation baking channel, a glue injection die bar connected with the die bar support, and an infrared radiation heating tube arranged in the thermal insulation baking channel. The light emitting diode epoxy resin encapsulation heating and curing device adopts the infrared radiation heating tube as the heat source for heating and curing, which can transmit heat to the surface of the heated material via air medium and heat convection as a common electric heating tube, and can radiate much infrared light to be absorbed by the material and activate internal molecules of the material to generate impact, thereby generating much heat and heating the material internally In this technology, the target material is heated by an infrared radiation heating, but the infrared radiation heating may cause the convection in hot air and the devices may be affected by the such convection, and the performance of the device may also be affected.

In a related art, it has provided a method for manufacturing OLED. In details it provides a dry glass frit comprising vanadium, phosphorous and a metal halide. The halide may be fluorine or chlorine. It also provides a method of producing a dry glass frit comprising calcining a batch material for the frit, then melting the batch material in an inert atmosphere, such as a nitrogen atmosphere. It has also provided another method of producing a dry glass frit comprising calcining a batch material for the frit, then melting the batch material in an air atmosphere, such as a nitrogen atmosphere.

This method used the way of undifferentiated heating. In other words, all regions in the chamber are heated by microwave, or other radiating source, so the microwave generator is required for a great power and the cost for manufacturing device is also increased. In addition, the needless regions are also heated, which may cause the devices be damaged.

### SUMMARY OF THE INVENTION

An aspect of an embodiment of the present disclosure is directed toward an OLED package heating device capable of improving the quality of the products, reducing the energy consumption and improving the performance and yield of the products.

Another aspect of an embodiment of the present disclosure is directed toward a method using the OLED package heating device.

An embodiment of the present disclosure provides an OLED package heating device, comprising:

a reaction chamber;

a mask located inside the reaction chamber; and

a microwave generator used to emit microwave;

wherein, the microwave transmits through the mask to sinter frit coated on a hard substrate.

According to one embodiment of the present disclosure, wherein the mask comprises a penetration region and a resistance region;

the resistance region prohibits the microwave emitted by the microwave generator to transmit through the mask;

the penetration region allows the microwave emitted by the microwave generator to transmit through the mask to heat the frit.

According to one embodiment of the present disclosure, further comprising a reflective plate located inside the reaction chamber and above the mask, wherein the reflective plate is used to reflect the microwave which has transmitted through the mask back to the frit.

According to one embodiment of the present disclosure, wherein the penetration region is located below the frit, and a planar shape of the penetration region is the same as the planar shape of the frit.

According to one embodiment of the present disclosure, wherein the microwave transmits vertically through the mask to the frit.

According to one embodiment of the present disclosure, wherein the microwave reaches inside of the reaction chamber through a waveguide tube.

According to one embodiment of the present disclosure, wherein a material of the reflective plate is formed by metal.

According to one embodiment of the present disclosure, wherein the mask, the hard substrate and the reflective plate are located in parallel to each other.

According to one embodiment of the present disclosure, wherein wave length of the microwave emitted by the microwave generator is from 1 mm to 1 m.

According to one embodiment of the present disclosure, wherein the operating power of the microwave generator is from 5 W to 12 W.

Another embodiment of the present disclosure provides a method for OLED package heating, comprising:

performing a sintering process to frit by using microwave;

wherein, the sintering process is performed in a chamber whose inside walls are covered with a microwave reflective layer.

According to one embodiment of the present disclosure, further comprising:

a microwave generator which emits and transmits the microwave to the inside of the reaction chamber by a waveguide tube.

According to one embodiment of the present disclosure, further comprising: providing a mask comprising a penetration region and a resistance region;

wherein, the resistance region prohibits the microwave emitted by the microwave generator to transmitted through the mask;

the penetration region allows the microwave emitted by the microwave generator to transmit through the mask to sinter the frit.

According to one embodiment of the present disclosure, wherein the penetration region is located below the frit, and a planar shape of the penetration region is the same as the planar shape of the frit.

According to one embodiment of the present disclosure, wherein the microwave transmits vertically through the mask to the frit.

According to one embodiment of the present disclosure, further comprising:

providing a reflective plate;

wherein, the reflective plate, the mask and the hard substrate are located in parallel to each other.

According to one embodiment of the present disclosure, wherein a wave length of the microwave is from 1 mm to 1 m.

According to one embodiment of the present disclosure, wherein time for sintering the frit is from 35 minutes to 45 minutes.

According to one embodiment of the present disclosure, wherein the operating power of the microwave generator is from 5 W to 12 W.

### BRIEF DESCRIPTIONS OF THE DRAWINGS

The accompanying drawings, together with the specification, illustrate exemplary embodiments of the present disclosure, and, together with the description, serve to explain the principles of the present disclosure.

FIG. 1 shows a diagram of the sintering process of the OLED packaging in the related art;

FIG. 2 shows a side sectional view of one embodiment of the OLED package heating device in the present disclosure;

FIG. 3 shows a structure diagram of the reaction chamber of one embodiment of the OLED package heating device in the present disclosure;

FIG. 4 shows a structure diagram of the mask of one embodiment of the OLED package heating device in the present disclosure;

FIG. 5 shows a diagram of the sintering process by microwave in an embodiment of the present disclosure.

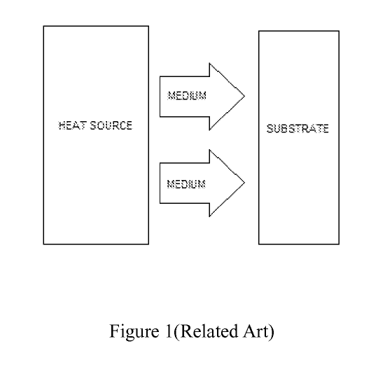

### DETAILED DESCRIPTIONS

The present disclosure will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

### EMBODIMENT 1

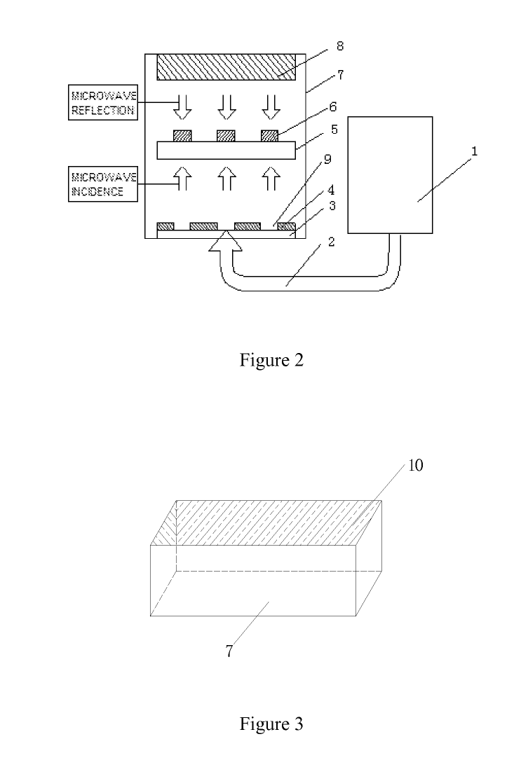

In one embodiment of the present disclosure, FIG. 2 shows a structure diagram of the side view of the OLED package heating device. As shown in FIG. 2, the OLED package heating device comprises a Reaction Chamber 7 and a Microwave Generator 1, the microwave is emitted by Microwave Generators 1, then the microwave is transferred from the bottom of Reaction Chamber 7 to the center of Reaction Chamber 7 by a Waveguide Tube 2. Reaction Chamber 7 comprises a Reflective Plate 8, a mask not shown in the Figure and a Hard Substrate 5; besides, the Frit 6 is coated on Hard Substrate 5. Wherein, Hard Substrate 5 is fixed at the center of Reaction Chamber 7, and Reflective Plate 8 is located at the top of Reaction Chamber 7 in order to reflect the microwave which has transmitted through the mask back to Frit 6. The mask is located at the bottom of Reaction Chamber 7 in order to shade a part of the microwave, and the other rest microwave can reach the surface of Frit 6.

Preferably, the shell of Reaction Chamber 7 is formed by metal in order to prevent the diffraction of the microwave or the refraction of the microwave from passing through Reaction Chamber 7. In addition, a metal film is coated on the inside walls of Waveguide Tube 2.

Furthermore, as shown in FIG. 2, the mask is formed by a Quartz Layer 3 and a Metal Layer 4, and there is a penetration region and a resistance region in the mask. Metal Layer 4 is located on the surface of Quartz Layer 3 and there is a plurality of Openings 9 on the surface of Metal Layer 4, and those Openings 9 are perpendicular to Quartz Layer 3. Each of the bottoms of Openings 9 is exposed on the surface of Quartz Layer 3. Consequently, the penetration region is formed. Wherein, the regions where covered by Metal Layer 4 form the resistance regions.

In addition, Hard Mask 5 is located above the mask in this embodiment of the present disclosure, the preferred Hard Substrate 5 is a glass substrate, the Frit 6 is coated on the surface of Hard Substrate 5 and located right above Opening 9, wherein, the planar shape of the lower surface of Frit 9 is the same as the planar shape of Opening 9 so that the microwave which has transmitted through Opening 9 can reach the lower surface of Frit 6.

Furthermore, Reflective Plate 8 is located above Hard Substrate 5. The mask, Hard Substrate 5 and Reflective Plate 8 are located in parallel to each other. The material of the reflective plate is metal.

Preferably, the operating power of the microwave generator is from 5 W to 12 W, such as 5 W, 8 W, 10 W or 12 W. The operating power can be controlled according to the requirements of the processes. The wave length of the microwave is from 1 mm to 1 m.

FIG. 3 shows a structure diagram of the reaction chamber of the OLED package heating device of the embodiment in the present disclosure. As shown in FIG. 3, the shell of Reaction Chamber 7 is preferably formed by metal, and a Metal Layer 10 is coated on the inside walls of Reaction Chamber 7. Alternatively, the inside walls of

Reaction Chamber 7 can also be formed by metal. Consequently, the diffraction of the microwave or the refraction of the microwave is prevented from passing through Reaction Chamber 7.

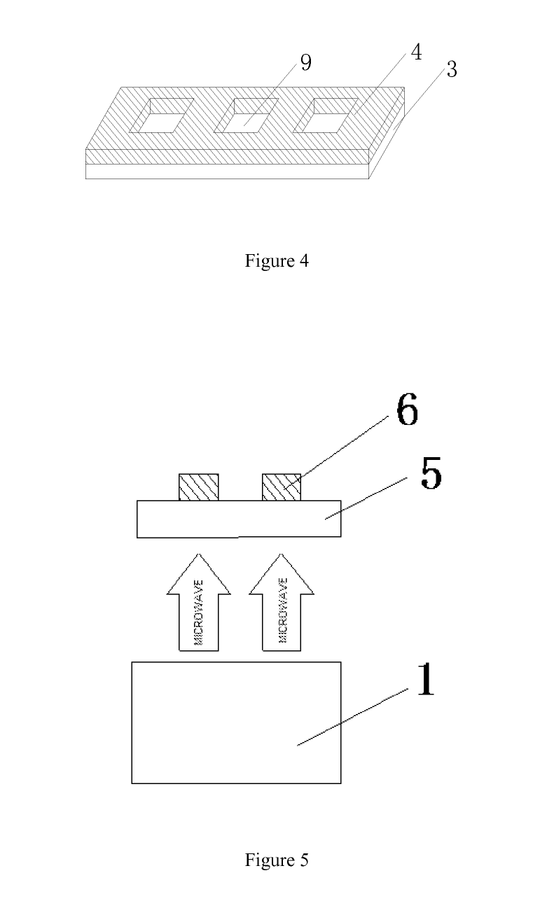

FIG. 4 shows a structure diagram of the mask plate of the OLED package heating device of the embodiment in the present disclosure. As shown from FIGS. 2 to 4, the mask is located in the bottom of the reaction chamber not shown in FIG. 4, and the mask comprises a penetration region and a resistance region. The mask is formed by a Quartz Layer 3 and a Metal Layer 4, wherein, Quartz Layer 3 is located in the bottom of the mask, Metal Layer 4 is located above Quartz Layer 3, and there is a plurality of Openings 9 on the surface of Metal Layer 4. The microwave is emitted by Microwave Generator 1, then the microwave transmits to the bottom of Reaction Chamber 7 by Waveguide Tube 2, after that, a part of the microwave can transmits through the mask and reach Opening 9, wherein the microwave can not pass through Metal Layer 4. Then the microwave will transmit through Hard Substrate 5, and finally the part of the microwave reaches Frit 6 so that Frit 6 is heated. Therefore, the solvent of Frit 6 is evaporated, and the sintering process is completed.

### EMBODIMENT 2

FIG. 5 shows a diagram of the sintering process by microwave. As shown in FIG. 5, the invention provides a method for the OLED package heating. In this method, the microwave is emitted by the microwave generator 1 and used for sintering Frit 6, wherein, Frit 6 is located on the surface of Hard Substrate 5.

Preferably, the sintering process is completed by the heating device of the Embodiment 1, referring to FIGS. 2 to 4; the heating device comprises a Reaction Chamber 7 and a Microwave Generator 1. The microwave is transferred from the bottom of Reaction Chamber 7 to the center of Reaction Chamber 7 by Microwave Generator 1 through a Waveguide Tube 2.

In addition, Reaction Chamber 7 comprises a metallic Reflective Plate 8, a mask not shown in the figure and a Hard Substrate 5, and Frit 6 is located on the Hard Substrate 5. Hard Substrate 5 is fixed at the center of Reaction Chamber 7, and Reflective Plate 8 is located at the top of Reaction Chamber 7, the mask is located at the bottom of Reaction Chamber 7. This mask comprises a Quartz Layer 3 located at bottom and a Metal Layer 4 located at top. Hard Substrate 5 and Reflective Plate 8 are located in parallel to each other.

The sintering process of OLED which uses the device above mentioned includes the following steps:

Firstly, a metal layer is coated on the surface of Quartz Layer 3, and then the metal layer is etched back until the upper surface of Quartz Layer 3 to remove the metal layer, i.e., to form Openings 9 in the penetration region and form a Metal Layer 4 with a plurality of Openings 9, the mask is formed by Quartz Layer 3 and Metal Layer 4 with Openings 9.

Secondly, the mask is fixed in the bottom of Reaction Chamber 7, and Reflective Plate 8 is located at the top of Reaction Chamber 7, Hard Substrate 5 with Frit 6 is fixed in Reaction Chamber 7 and between Reflective Plate 8 and the mask. Hard Substrate 5, Reflective Plate 8 and the mask are ensured to be located in parallel to each other.

Besides, each Frit 6 is located right above Opening 9 of the mask and overlapped with Opening 9, and the bottom planar shape of Frit 6 is the same as the shape of Opening 9.

Then Microwave Generator 1 is started to emit the microwave, wherein, the wavelength of the microwave is from 1 m to 1 mm. After that, the microwave reaches Reaction Chamber 7 by a Waveguide Tube 2. As the inside walls of Waveguide Tube 2 are covered with the metal layer, the microwave can not transmit through Waveguide Tube 2, which ensures that the microwave reaches Reaction Chamber 7 through Waveguide Tube 2. This can not only effectively avoid the waste which is caused by the penetrated microwave from Waveguide Tube 2, but also protect the operating personnel from the damage of the microwave irradiation.

When the microwave transmits through Waveguide Tube 2 and reaches the bottom of Reaction Chamber 7, the microwave has to pass through the mask to reach the inside of Reaction Chamber 7. As there is a Quartz Layer 3 in the bottom of the mask, the microwave can transmits through Quartz Layer 3 but can not transmit through Metal Layer 4, thus the microwave only transmits through Openings 9 to reach the inside of Reaction Chamber 7, the position and the direction of the microwave is as shown in FIG. 2, and then Hard Substrate 5 is further penetrated to heat Frit 6 on Hard Substrate 5.

By reason of the metal oxide as the main component of Frit 6, Frit 6 also contains a certain amount of the volatile solvent, i.e., the water inside Frit 6, and the microwave can only heat the ionic and/or polar molecules, those molecules can absorb the microwave and the mixtures contain those materials. Therefore, Frit 6 can be heated separately so that the atmosphere will not be heated. Next, the process of sintering is completed. Hence, the energy consumption is reduced and the cool-down time for the prevent maintenance is also reduced.

Besides, as the microwave can be absorbed by the molecules of Frit 6, Frit 6 can be heated inside and the temperature of the material for sintering can also be reduced due to the reduced activation energy of Frit 6, the activation energy means the melting point. Therefore, the consumed power for production is reduced. Moreover, the transparent packaging boundary can be produced by the process of sintering, thus the process level is improved.

Furthermore, when a part of the microwave which is not absorbed by Frit 6 transmits through Frit 6, Reflective Plate 8 will reflect the microwave, the position and the direction of the reflected microwave as shown in FIG. 2 so that Frit 6 can be heated and sintered by the microwave once again. The energy consumption of the production may be further reduced.

The operating power of the microwave generator is from 5 W to 12 W, such as 5 W, 8 W, 10 W or 12 W; the working time of Microwave Generator 1 is from 35 minutes to 45 minutes, such as 35 minutes, 40 minutes or 45 minutes, in order to heat Frit 6. In this embodiment of the present disclosure, the sintering degree of Frit 6 can be controlled by the power and the working time of Microwave Generator 1 in order to meet the various requirements of the sintering process.

Finally, the ultraviolet adhesive is coated, and after the ultraviolet adhesive is cured, the process of packaging is performed by laser. The follow-up processes are the same as conventional processes, which will not be explained in detail here.

In summary, as the embodiment of the present disclosure applied the above techniques to perform the laser packaging process, it can complete the sintering process with the rapidly heated frit. And in the reaction chamber, there is a mask with a plurality of openings in the reaction chamber, so the microwave only through these openings to achieve the upward radiation in order to heat the frit which is right above the openings. A reflective plate is located at the top of the reaction chamber. This reflective plate can produce a reflection of the microwave, so Frit 6 can be heated and sintered by the microwave once again. Therefore, the consumption and the cost of the production are reduced, the quality of the heating and sintering processes is improved, and the yield of the products is also improved.

While the present disclosure has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An OLED package heating device, comprising:
a reaction chamber;
a mask located inside the reaction chamber; and
a microwave generator used to emit microwave;
wherein, the microwave transmits through the mask to sinter frit coated on a hard substrate.

2. The device as claimed in claim 1, wherein the mask comprises a penetration region and a resistance region;
the resistance region prohibits the microwave emitted by the microwave generator to transmit through the mask;
the penetration region allows the microwave emitted by the microwave generator to transmit through the mask to heat the frit.

3. The device as claimed in claim 2, further comprising a reflective plate located inside the reaction chamber and above the mask, wherein the reflective plate is used to reflect the microwave which has transmitted through the mask back to the frit.

4. The device as claimed in claim 2, wherein the penetration region is located below the frit, and a planar shape of the penetration region is the same as the planar shape of the frit.

5. The device as claimed in claim 2, wherein the microwave transmits vertically through the mask to the frit.

6. The device as claimed in claim 1, wherein the microwave reaches inside of the reaction chamber through a waveguide tube.

7. The device as claimed in claim 1, wherein a material of the reflective plate is formed by metal.

8. The device as claimed in claim 1, wherein the mask, the hard substrate and the reflective plate are located in parallel to each other.

9. The device as claimed in claim 1, wherein wave length of the microwave emitted by the microwave generator is from 1 mm to 1 m.

10. The device as claimed in claim 1, wherein the operating power of the microwave generator is from 5 W to 12 W.

11. A method for OLED package heating, comprising:
performing a sintering process to frit by using microwave;
wherein, the sintering process is performed in a chamber whose inside walls are covered with a microwave reflective layer.

12. The method as claimed in claim 11, further comprising:
a microwave generator which emits and transmits the microwave to the inside of the reaction chamber by a waveguide tube.

13. The method as claimed in claim 11, further comprising:
providing a mask comprising a penetration region and a resistance region;
wherein, the resistance region prohibits the microwave emitted by the microwave generator to transmitted through the mask;
the penetration region allows the microwave emitted by the microwave generator to transmit through the mask to sinter the frit.

14. The method as claimed in claim 13, wherein the penetration region is located below the frit, and a planar shape of the penetration region is the same as the planar shape of the frit.

15. The method as claimed in claim 13, wherein the microwave transmits vertically through the mask to the frit.

16. The method as claimed in claim 14, further comprising:
providing a reflective plate;
wherein, the reflective plate, the mask and the hard substrate are located in parallel to each other.

17. The method as claimed in claim 13, wherein a wave length of the microwave is from 1 mm to 1 m.

18. The method as claimed in claim 11, wherein time for sintering the frit is from 35 minutes to 45 minutes.

19. The method as claimed in claim 13, wherein the operating power of the microwave generator is from 5 W to 12 W.
